(19) United States
(12) Patent Application Publication
(10) Pub. No.: US 2012/0149814 A1
(43) Pub. Date: Jun. 14, 2012

(54) ULTRAHYDROPHOBIC COATING AND METHOD FOR MAKING THE SAME

(76) Inventors: Jinyong Li, Shanghai (CN); Chunbo Ran, Shanghai (CN); Jianli Cheng, Albany, CA (US)

(21) Appl. No.: 13/390,339

(22) PCT Filed: Aug. 4, 2010
(86) PCT No.: PCT/EP10/61334

§ 371 Date: Mar. 1, 2012

(30) Foreign Application Priority Data
Aug. 19, 2009 (EP) 09168208.8

(51) Int. Cl. C08K 5/3415

(52) U.S. Cl. 524/104

(57) ABSTRACT

Compositions for making ultrahydrophobic coatings are described. The compositions comprise microclusters having particles with diameters from 5 nm to 25 microns. The coatings applied are ultrahydrophobic and display a contact angle against water of greater than 130° and a sliding angle of less than 20°.

The present invention is directed to a composition suitable to yield an ultrahydrophobic coating and a method for making the same. More particularly, the present invention is directed to an ultrahydrophobic coating comprising “strawberry-like” aggregates or microclusters having particles with diameters from 5 nm to 25 microns. Such a coating is prepared by generating the microclusters and applying a composition comprising the same to a substrate like, for example, a fabric, ceramic, plastic, paper, glass or metal surface. Substrates with the coating of this invention unexpectedly display a contact angle against water of greater than 130° and a sliding angle of less than 20°.

Droughts, poor irrigation and insufficient plumbing systems are just some of the reasons that cause water shortages in certain regions. Shortages of water can create serious social problems, such as health issues, that are a direct result of inadequate cleaning applications in the absence of sufficient amounts of water.

Efforts for cleaning surfaces with limited amounts of water have been made. In fact, the cleaning of surfaces that attempt to mimic the surface of a lotus leaf has been investigated. Taro leaves, for example, have been used as templates for polystyrene structures that can display a lotus leaf effect. Such structures can be used for coatings that possess superhydrophobic properties. Articles with surfaces that are difficult to wet, i.e., articles with superhydrophobic surfaces, are therefore desirable since they possess self-cleaning properties when water is present at low volumes. Moreover, such coatings, subsequent to being applied, yield surfaces that make cleaning easier and faster for the consumer.

While superhydrophobic surfaces are desirable, compositions that result in such surfaces can be difficult to manufacture and can result in surfaces that display inferior self cleaning, a direct result, for example, of their characteristic contact angles that do not always exceed 125° against water. Moreover, there is no known process for a convenient and energy efficient way to manufacture compositions that result in coatings that reliably display high contact angles and simultaneously low sliding angles.

There is an increasing interest to consistently develop ultrahydrophobic coatings that result in surfaces displaying high contact angles against water as well as low sliding angles. This invention, therefore, is directed to a composition for yielding an ultrahydrophobic coating comprising strawberry-like aggregates or microclusters whereby the same comprises particles with diameters from 5 nm to 25 microns. The microclusters are prepared via a bottom-up process that utilizes a multi-solvent system to reliably produce compositions that yield coatings with surprisingly superior contact angles against water as well as low sliding angles when applied to planar and/or non-planar surfaces.

Efforts have been disclosed for preparing hydrophobic surfaces. In Thin Solid Films 515 (2006), pp. 1539-1543, Hongli et al.; Applied Surface Science 253 (2007) pp. 8830-8834, Xu et al.; Journal of Physics D: Applied Physics 40 (2007), pp. 3485-3489, Zhiqing et al., and Journal of Colloid and Interface Science 322 (2008), pp. 1-5, Shuaixia et al., superhydrophobic surfaces are described.

Other efforts have been disclosed for making hydrophobic surfaces. In U.S. Pat. Nos. 6,683,126 B2 and 7,196,043 B2, compositions for producing difficult to wet surfaces and compositions for yielding self-cleaning surfaces, respectively, are described.

Still other efforts have been disclosed for making hydrophobic surfaces. In U.S. Pat. Nos. 7,279,197 B2 and 7,459,197 B2, anti-icing coatings and reversibly adaptive rough micro- and nanostructures, respectively, are described.

None of the additional information above describes a composition for making an ultrahydrophobic coating having a contact angle of greater than 130° and simultaneously a sliding angle of less than 20° whereby the coating is the result of a bottom-up process that utilizes a multi-solvent system to produce a composition with microclusters that is a precursor to the ultrahydrophobic coating.

In a first aspect, the present invention is directed to a composition suitable to yield an ultrahydrophobic coating; the composition comprises a microcluster having particles with diameters from 5 nm to 25 microns, the microcluster having a diameter from 100 nm to 150 microns.

In a second aspect, the invention is directed to a method for making the composition of the first aspect of this invention.

In a third aspect, the present invention is directed to a method for making an ultrahydrophobic coating with the composition described in the first aspect of this invention.

In a fourth aspect, the present invention is directed to the ultrahydrophobic coating made in the third aspect of this invention.

All other aspects of the present invention will more readily become apparent upon considering the detailed description and examples which follow.

Microcluster, as used herein, is meant to mean a bundle of particles, and preferably, a bundle of particles that form an aggregate of particles of the same or varying sizes (i.e., strawberry-like appearance). Ultrahydrophobic, as use herein, means having a contact angle of at least 130° against water and a sliding angle of less than 20°. Heterogeneously sized particles in a microcluster means having particles with different or varying size diameters in the microcluster. Homogeneously sized particles in a microcluster means having particles with substantially the same size diameters in the microcluster. Substantially the same size means having all particles with diameter sizes within 5% of each other.

Contact angle, as used herein, means the angle at which a water/vapor interface meets a solid surface. Such an angle maybe measured with a goniometer or other water droplet shape analysis systems. Sliding angle, as used herein, means the tilt angle of a surface at which a 7 mg drop of water slides. Bottom-up process means particles are used to create aggregates. Diameter is meant to mean the largest measurable distance on a particle or aggregate in the event a well-defined sphere is not generated. Multi-solvent system, as used herein, means using solvent in at least two steps, and often, not the same solvent. Such a multi-solvent system preferably uses a solvent that is substantially aqueous and a solvent that is substantially non-aqueous, where substantially means at least ninety percent by weight, and preferably, one hundred percent by weight. Composition for yielding an ultrahydrophobic coating means a composition comprising from about 5 to about 50%, and preferably, from 12 to 40%, and most preferably, from 15 to 30% by weight microcluster, based on total weight of composition and including all ranges subsumed therein.

All ranges defined herein are meant to include all ranges subsumed therein. Comprising, as used herein, is meant to include consisting essentially of and consisting of. For the avoidance of doubt and by way of illustration in this specification, a composition with particles comprising polystyrene yields support for a composition with particles consisting essentially of and consisting of polystyrene.

In this description, the term “particle” should be understood to include the plural: “particles”.

When preparing the composition comprising the microclusters (i.e., the composition which is a precursor to an ultrahydrophobic coating), typically a particle is selected whereby the particle is not soluble but dispersable in a first solvent and not soluble but able to swell when subjected to a second solvent while being dispersed in the first solvent. In an often preferred embodiment, the particle is charged when dispersed in the first solvent. Often, the particle (i.e., already prepared and polymerized) selected for use in this invention is one which is derived from monomers suitable to undergo free radical polymerization.

Illustrative yet non-limiting examples of the types of monomers suitable to produce particle that may be used in this invention include styrene and derivatives thereof like 1-methyl-4-vinylbenzene, 1-tert-butyl-4-vinylbenzene, 1-bromo-4-vinylbenzene, 4-vinylphenyl acetate, and acrylates like 2-hydroxyethyl acrylate (HEA), tert-butyl acrylate (t-BA), n-butyl acrylate (n-BA), methyl methacrylate (MMA), 2-(dimethylamino)ethyl methacrylate (DMAEMA), 2-hydroxyethyl methacrylate (HEMA), glycidyl methacrylate (GMA), and acrylamides like, for example, dimethylacrylamide (DMA), N-isopropylacrylamide (NIPAM), and acrylic acid and derivatives thereof, like methacrylic acid, and acrylonitriles like methacrylonitrile, and dienes like 4-vinylpyridine (4VP), vinyl propionate, vinyl butyrate, vinyl ether, allylbutyl ether, allylglycidyl ether, maleic acid, vinyl acetate as well as copolymers and miscible and immiscible blends of the same.

Particles comprising copolymers of polystyrene are often preferred and they include high impact polystyrene (HIPS), acrylonitrile butadiene styrene (ABS), styrene acrylonitrile (SAN), styrene maleic anhydride (SMA), styrene acrylates (including copolymers of styrene and tert-butyl acrylate or n-butylacrylate) or mixtures thereof. In a most preferred embodiment, however, the particle selected for use in this invention is a polystyrene particle. In another most preferred embodiment, from 0.01 to about 8%, especially, 0.5 to 5%, and most especially, 2 to 4% by weight filler is added to the particle during polymerization (to yield filled particle), based on total weight of particle and filler and including all ranges subsumed therein. The filler which may be used is limited only to the extent that it should enhance the ultrahydrophobic properties of the compositions prepared and that comprise microcluster. Illustrative yet non-limiting examples of the filler which may be employed include silica, calcium silicate, zinc oxide, titanium dioxide, calcium carbonate or mixtures thereof. In an especially preferred embodiment, calcium carbonate is the filler of choice.

The particle selected for use in preparing the composition with microclusters of this invention typically has a diameter that is no larger than 20 microns, and preferably from 5 nm to 15 microns, and most preferably, from 100 nm to 10 microns, including all ranges subsumed therein.

Particle selected may be homogeneous in size, but preferably, a heterogeneous collection of particles is used to prepare composition with microclusters of heterogeneously sized particles. When preparing such composition, particle, in no particular order, is combined with a solvent the particle is not soluble in, such as a substantially aqueous solvent. Water or a water and alcohol (preferably C₁₋₄ alcohol) solution is generally preferred and a charging or initiator agent which charges the particle may be employed to assist in dispersing the particle of choice within the aqueous-based solvent. Enough initiator agent is optionally used so that from about 5 to 50%, and preferably, from 12 to 40%, and most preferably, from 15 to 30% by weight particle is present and dispersed in the dispersion, based on total weight of dispersion (solvent, particle and initiator agent) and including all ranges subsumed therein. Typically, therefore, the amount of initiator agent used is from 0.001 to 10%, and preferably, from 0.1 to 5%, and most preferably, from 0.2 to 3% by weight, based on total weight of the dispersion and including all ranges subsumed therein.

The initiator agent which charges the particle can be one which renders the particle positive or negative and is only limited to the extent that the same is suitable for use in the desired dispersion. Often, the initiator agent used is an oxidizer or radical initiator like ammonium persulfate, sodium persulfate, potassium persulfate, magnesium peroxide, benzoyl peroxide, cumene hydroperoxide, lauryl peroxide, sodium chlorite, sodium bromate, mixtures thereof or the like.

Other suitable dispersion initiator agents suitable for use include 2,2′-azobisisobutryonitrile, 2,2′-azobis (2-methylpropionamidine) dihydrochloride, 2,2′-azobis (propionitrile), 2,2′-azobis (valeronitrile), 2-(carbamoylazo)-isobutyronitrile, mixtures thereof or the like. In a preferred embodiment, the initiator agent used is ammonium persulfate, 2,2′-azobisisobutryonitrile or a mixture thereof, the former made commercially available by Sigma-Aldrich and the latter made commercially available by Dupont under the Vazo® brand name.

It is within the scope of this invention to optionally employ a cross-linking agent in order to expedite the formation of the desired composition with microclusters of this invention. Suitable cross-linking agents that may be used include, for example, divinyl benzene, 1-vinyl-4-(4-(4-vinylphenoxy)butoxy)benzene, polystyrene resins containing tetrahydrofuran derived cross-linkers, 1,2-polybutadiene, 1,4-divinyloxybutane, divinylsulfone, triallyl phosphate, zinc diacrylate, zinc dimethacrylate, trimethylene glycol diacrylate, trimethylol propane trimethacrylate, diallyphthalate, diallylacrylamide, polyethylene glycol dimethacrylate, polypropylene glycol dimethacrylate, pentaerythritol tetramethacrylate, pentaerythritol trimethacrylate, pentaerythritol dimethacrylate, trimethylolpropane trimethacrylate, dipentaerythritol hexamethacrylate, dipentaerythritol pentamethacrylate, glycerol trimethacrylate, mixtures thereof or the like. When used, the cross-linking agent most preferred is divinyl benzene. Typically, if used, cross-linking agent makes up from 0.01 to 15, and preferably, from 0.1 to 10, and most preferably, from 0.5 to 5% by weight of the dispersion comprising particle, initiator agent, solvent and cross-linking agent, and including all ranges subsumed therein. Mixing is preferred and heating is optional. In a preferred embodiment, contents are mixed or agitated for 1 to 5 hours at temperatures from 25° C. to 95° C., and most preferably, no higher than 85° C.

For clarity, more then one dispersion may be made with homogeneously or heterogeneously sized particles in each dispersion and they may subsequently be combined with each other either before or after (preferably before) they are combined with additional solvent for particle swelling and desired microcluster formation.

Subsequent to generating the dispersion of particles, the same may be combined with at least one additional solvent (preferably one additional solvent for manufacturing simplificity) that causes the particle in the dispersion to eventually both swell and aggregate, resulting in the desired composition suitable to yield an ultrahydrophobic coating. Such a solvent can be aqueous (e.g., water) but is preferably substantially non-aqueous.

The additional solvent or solvents that may be used are limited only to the extent that the same eventually result(s) in swelling and aggregation of the particles in the dispersion. Solvents suitable for use to swell and induce aggregation of the particles in the dispersion include, for example, water, isopropyl alcohol, xylene, toluene, diisobutyl phthalate, tetrahydrofuran, 2-alkyl (especially 2-methyl) tetrahydrofuran, mixtures thereof or the like. In a preferred embodiment, the additional or second solvent employed in this invention is tetrahydrofuran, isopropyl alcohol or a mixture thereof.

In an often preferred embodiment, the aggregation of particles has a first set of particles with diameters from greater than 400 nm to 20 microns and a second set of particles with diameters from 5 to 400 nm. In another often preferred embodiment, the aggregation of particles (i.e., microcluster) comprises from 1.2 to 3, and preferably, from 1.3 to 2.7, and most preferably, from 1.5 to 2.5 times more second set of particles than first set of particles based on total weight of microcluster. In another especially preferred embodiment, the microcluster has a diameter from 100 nm to 150 microns, and preferably, from 100 nm to 15 microns, and most preferably, from 200 nm to 10 microns, including all ranges subsumed therein.

When combining solvents, it is desirable for the composition for yielding an ultrahydrophobic coating to comprise from 0.1 to 25%, and preferably, from 0.15 to 15%, and most preferably, from 0.2 to 7% by weight substantially non-aqueous solvent, based on total weight of substantially aqueous and substantially non-aqueous solvent, including all ranges subsumed therein.

In an especially preferred embodiment, it is within the scope of the present invention to add binder to the desired composition to enhance ultrahydrophobic coating adhesion to substrate. Such a binder is preferably first added to the solvent that results in particle swelling and aggregation. Typically, if used, binder makes up from 0.1 to 5%, and preferably, from 0.3 to 3.0%, and most preferably, from 0.5 to 1.5% by weight of the composition for yielding an ultrahydrophobic coating, based on total weight of the composition used and including all ranges subsumed therein.

Binders suitable for use in this invention include, for example, linear, branched and/or cyclic polydimethylsiloxane (PDMS) as well as polystyrene, copolymers of PDMS and polystyrene and/or polymethyl methacrylate, mixtures thereof or the like.

Subsequent to generating the composition suitable to yield an ultrahydrophobic coating, the composition is immediately ready for use.

There is no limitation with respect to how the composition is applied to a substrate as long as the region on the substrate identified for coating is coated. Typically, the composition suitable to yield an ultrahydrophobic coating is applied by brushing composition on to substrate, by dipping substrate into the composition or by pouring composition onto the substrate identified. In a preferred embodiment, however, the composition suitable to yield an ultrahydrophobic coating is applied by spraying the same on to the substrate targeted for coating. Such spraying may be achieved with a spraying device having, for example, a compressor and spray gun for spraying composition. In an especially preferred embodiment, however, spraying is achieved by using a conventional spray bottle so that composition may be easily applied in commercial and/or domestic applications, especially domestic applications.

The amount of composition that should be applied is essentially not limited but it is preferred that the entire surface targeted is coated. When a transparent surface is being coated, over application should be avoided and refractive indexes of the coating and surface should be substantially the same so that upon drying, the ultrahydrophobic coating cures or dries transparent.

It is within the scope of this invention to instruct the consumer to shake the composition suitable to yield an ultrahydrophobic surface prior to use. After application, the ultrahydrophobic coating typically takes from fifteen to sixty minutes to dry. There is no limitation with respect to the type of surface that may be treated with the coating of this invention. Preferably, however, the surface is a window (polymeric or glass), a surface in a kitchen, bathroom, food processing plant, hospital setting or any other setting requiring hard surface cleaning, where cleaning can include prevention of marine fouling as well as bacteria fouling.

Subsequent to drying (e.g., by air drying or applying heat) the ultrahydrophobic coating of this invention contained microclusters that were from 100 nm to 1000 microns, and preferably, from 900 nm to 30 microns, and most preferably, from 4 microns to 15 microns, including all ranges subsumed therein. Moreover, subsequent to drying, the coating unexpectedly yields a contact angle against water of greater than 140° and a sliding angle of less than 20°. Preferably, the contact angle against water is from 145 to 180° and the sliding angle is from 0.1 to 15°, and most preferably, the contact angle is from 150 to 180° and the sliding angle is from 0.1 to 5°.

The following examples are provided to facilitate an understanding of the invention. The Examples are not intended to limit the scope of the claims.

### EXAMPLE 1

Compositions suitable to yield ultrahydrophobic coatings were prepared by charging water with polystyrene particles. The resulting solution contained about 20% by weight polystyrene particles having diameters of about 200 nm. Potassium persulfate was used (0.35%) as an initiator agent. Divinyl benzene was added (1%) to the dispersion as a crosslinking agent. The resulting dispersion was combined with tetrahydrofuran (weight ratio of water:tetrahydrofuran about 4:1) and mixed under moderate stirring for about 1.5 hours. The swollen polystyrene particles obtained were assessed with a Malvern Zetasizer instrument, and it was determined that the same had diameters ranging from about 720 nm to 4.35 microns. The results indicated that the polystyrene particles did swell and aggregate when the second solvent was added. The composition made was sprayed onto a paper surface and upon drying a coating displaying a contact angle of about 150° and a sliding angle of about 10° was produced. Scanning electron morphologies indicated the formation of microclusters (about 10 microns) of polystyrene.

### EXAMPLE 2

Compositions suitable to yield ultrahydrophobic coatings were prepared by charging water with polystyrene particles. The resulting dispersion contained about 20% by weight polystyrene particles having a size distribution (i.e., diameters) from 200-900 nm, and therefore, heterogeneously sized particles. Sodium persulfate was used as an initiator agent (about 0.2%). Divinyl benzene was added (1% and with moderate shear) to the dispersion as a crosslinking agent to assist in producing a dispersion with crosslinked polystyrene particles. The resulting dispersion was stable and contained negatively charged polystyrene particles.

A second solution was made with tetrahydrofuran and polydimethylsiloxane binder (about 20% polydimethylsiloxane). Dispersion (160 ml) and second solution with tetrahydrofuron (10 ml) were combined so that the resulting composition contained about 15 times more water than tetrahydrofuran. Dispersed particles were allowed to swell and aggregate for about fifteen minutes and the resulting composition was one which was suitable to yield an ultrahydrophobic coating upon application to a surface.

### EXAMPLE 3

Compositions similar to the one made in Example 2 were sprayed onto a transparent glass surface. Enough was sprayed to cover the surface but not to render the surface opaque. Upon drying, the transparent glass surface was coated with an ultrahydrophobic surface having microcluster with a first set of particles greater than 400 nm to 20 microns and second set of particles with diameters from 5 to 400 nm at a second particle to first particle set ratio of 2:1.

Seven milligram drops of water were applied to coated glass surface. The resulting drops were assessed by using a Krüss Easy Drop Standard DSA instrument. Unexpectedly, it was determined that contact angles observed were at least 150° and the sliding angles observed were about 5° for each of the coated surfaces.

### EXAMPLE 4

Compositions similar to the one made in Example 3 were applied with a spray bottle to hard plastic, ceramic and steel surfaces. Enough composition was sprayed to cover the surface. Upon drying, the surfaces were coated with an ultrahydrophobic coating having microstructures with homogeneously sized particles (diameters about 200 nm) whereby the microclusters themselves were about 5 microns. About seven (7) mg drops of water were dispersed onto the coated surfaces. The resulting drops were assessed by using a Krüss Easy Drop Standard DSA instrument. The contact angles observed were about 150° and the sliding angles were about 10°.

### EXAMPLE 5

Compositions similar to the one made in Example 3 were sprayed onto ceramic surfaces (about 25 cm²). Upon drying, the ceramic surfaces were covered with an ultrahydrophobic coating having microclusters with heterogeneously sized particles, about 700 nm and 200 nm at a 1:2 weight ratio, respectively. Calcium carbonate powder was dusted onto the coated substrates as an artificial soil. The calcium carbonate was easily removed from the substrates with about 1 mL of water. Assessment of the coatings revealed sliding angles from 2 to 3°.

### EXAMPLE 6

The compositions made in this example were similar to the compositions made in Example 2 except that polystyrene was used as a binder in lieu of polydimethylsiloxane. The resulting composition was sprayed ultrahydrophobic coating.

The results demonstrate that the compositions made according to the process of this invention surprisingly yield ultrahydrophobic surfaces with superior properties, including excellent contact and sliding angles.

1. A method for making a composition capable of producing an ultrahydrophobic coating, the method producing microclusters via a bottom-up process whereby particles are used to produce aggregates and utilizing a multi-solvent system, the method comprising the steps of:
combining, in no particular order, a substantially aqueous first solvent and particles which are not soluble but dispersible in the substantially aqueous first solvent to produce a dispersion;
swelling and aggregating the particles by combining a substantially non-aqueous second solvent with the dispersion to produce a composition, the substantially non-aqueous second solvent being one which causes particles in the dispersion to swell and aggregate to produce microclusters having particles with diameters from 5 nm to 25 microns; and
recovering the composition.

2. The method according to claim 1 wherein the microcluster has a diameter from 100 nm to 150 microns.

3. The method according to claim 1 wherein the method further comprises the step of adding an initiator agent to the first solvent wherein the initiator agent charges the particles.

4. The method according to claim 3 wherein the initiator agent is ammonium persulfate, sodium persulfate, potassium persulfate, magnesium peroxide, benzoyl peroxide, cumene hydroperoxide, lauryl peroxide, sodium chlorite, sodium bromate, azobisisobutryonitrile, 2,2′-azobis(2-methylpropionamidine) dryhydrochloride, 2,2′-azobis(propionitrile), 2,2′-azobisisobutryonitrile, or a mixture thereof.

5. The method according to claim 1 wherein the particle is a polymerization product of styrene, 1-methyl-4-vinylbenzene, 1-tert-butyl-4-vinylbenzene, 1-bromo-4-vinylbenzene, 4-vinylphenyl acetate, 2-hydroxyethyl acrylate (HEA), tert-butyl acrylate (t-BA), n-butyl acrylate (n-BA), methyl methacrylate (MMA), 2-(dimethylamino)ethyl methacrylate (DMAEMA), 2-hydroxyethyl methacrylate (HEMA), glycidyl methacrylate (GMA), dimethylacrylamide (DMA), N-isopropylacrylamide (NIPAM), methacrylic acid, methacrylonitrile, 4-vinylpyridine (4VP), vinyl propionate, vinyl butyrate, vinyl ether, allylbutyl ether, allylglycidyl ether, maleic acid, vinyl acetate, copolymers thereof or blends of polymers thereof.

6. The method according to claim 1 wherein the particle is polystyrene, high impact polystyrene (HIPS), acrylonitrile butadiene styrene (ABS), styrene acrylonitrile (SAN), styrene maleic anhydride (SMA), a copolymer of styrene and tert-butyl acrylate, a copolymer of styrene and n-butylacrylate or a mixture thereof.

7. The method according to claim 1 wherein the first solvent is water or a water and C₁₋₄ alcohol mixture.

8. The method according to claim 1 wherein the microclusters have diameters from 100 nm to 15 microns.

9. The method according to claim 4 wherein the initiator agent is potassium persulfate, 2,2′-azobisisobutryonitrile or a mixture thereof.

10. The method according to claim 1 wherein the first solvent further comprises a cross-linking agent which is divinyl benzene, 1-vinyl-4-(4-(4-vinylphenoxy)butoxy)benzene, polystyrene resins containing tetrahydrofuran derived cross-linkers, 1,2-polybutadiene, 1,4-divinyloxybutane, divinylsulfone, triallyl phosphate, zinc diacrylate, zinc dimethacrylate, trimethylene glycol diacrylate, trimethylol propane trimethacrylate, diallyphthalate, diallylacrylamide, polyethylene glycol dimethacrylate, polypropylene glycol dimethacrylate, pentaerythritol tetramethacrylate, pentaerythritol trimethacrylate, pentaerythritol dimethacrylate, trimethylolpropane trimethacrylate, dipentaerythritol hexamethacrylate, dipentaerythritol pentamethacrylate, glycerol trimethacrylate or a mixture thereof.

11. The method according to claim 10 wherein the cross-linking agent is divinyl benzene.

12. The method according to claim 1 wherein the second solvent comprises isopropyl alcohol, xylene, toluene, diisobutyl phthalate, tetrahydrofuran, 2-alkyl tetrahydrofuran or a mixture thereof.

13. The method according to claim 1 wherein the second solvent is tetrahydrofuran, isopropyl alcohol or a mixture thereof.

14. The method according to claim 1 wherein the second solvent further comprises a binder added thereto prior to being mixed with the first solvent.

15. The method according to claim 1 wherein the particle comprises filler.

16. A method for making an ultrahydrophobic coating on a surface, the method comprising the steps of applying the composition suitable to produce an ultrahydrophobic coating made in claim 1 to a surface and allowing the composition to dry to produce the ultrahydrophobic coating, the ultrahydrophobic coating having a contact angle against water of greater than 130° and a sliding angle of less than 20°.

17. The method according to claim 6 wherein the ultrahydrophobic coating has a contact angle against water which is from 145 to 180° and a sliding angle which is from 0.1 to 15°.

18. The ultrahydrophobic coating obtainable by the method of claim 16.

19. The composition of claim 1, the composition being a precursor to an ultrahydrophobic coating.
